(19) United States
(12) Patent Application Publication
(10) Pub. No.: US 2018/0022947 A1
(43) Pub. Date: Jan. 25, 2018

(54) ELECTRON BEAM CURING OF WATER BASED INKJET INKS

(71) Applicant: COMET Technologies USA, Inc., Davenport, IA (US)

(72) Inventor: Stephen C. Lapin, Waterford, WI (US)

(73) Assignee: COMET Technologies USA, Inc., Davenport, IA (US)

(21) Appl. No.: 15/720,281

(22) Filed: Sep. 29, 2017

Related U.S. Application Data
(63) Continuation of application No. PCT/US2016/024904, filed on Mar. 30, 2016.
(60) Provisional application No. 62/143,375, filed on Apr. 6, 2015.

(51) Int. Cl. C09D 11/102; B41J 3/407; C09D 11/30; B41J 11/00; C09D 11/033; C09D 11/101

(52) U.S. Cl. CPC C09D 11/102; C09D 11/033; C09D 11/101; C09D 11/30; B41J 11/0015; B41J 3/4073

(57) ABSTRACT

Novel water-based electron beam (EB) curable inkjet inks along with printed substrates, drying processes, and printing equipment are disclosed. The inks are effectively dried by EB energy alone or in combination with optional thermal drying.

### CROSS REFERENCE TO RELATED APPLICATIONS

This application is a continuation of International Patent Application No. PCT/US2016/024904, filed on Mar. 30, 2016 which claims the benefit of U.S. Provisional Application No. 62/143,375 filed Apr. 6, 2015, each of which is hereby incorporated by reference.

### BACKGROUND

Ink jet printing technology has matured of late. The number of inkjet printers in use has rapidly expanded since the late 1970's. The range of available inkjet printing equipment now includes: low cost home office printers, professional printers, wide format printers for displays and billboards, commercial sheet-fed printers, and web presses running over 400 ft/min.

One common type of inkjet printing is known as drop-on-demand (DOD) printing. The tiny ink drops used in the DOD process may be generated in the print heads by thermal heating or by pressure generated by a piezoelectric material. Thermal print heads require inks with a volatile component that are vaporized by pulsed heating within the print heads. Water is commonly used in order to avoid the generation and emission of solvent vapors. Piezoelectric print heads may use also use water based inks. Water based inks work well on porous substrates such as paper but are challenging to dry on non-porous substrates such as plastics. Another disadvantage of water based inks is that they have poor resistance properties and may run or rub off if the printed materials is subject to moisture, household products, or abrasion.

Since piezoelectric print heads do not need to generate vapors to generate and drive the drops they can also use ultraviolet (UV) curable inks. UV curable inks contain photoinitiators and monomers that dry by rapid polymerization upon exposure to UV energy. UV curable inks work well on non-porous substrates since they do not need to absorb into the substrate in order to dry. UV curable inks are crosslinked upon curing so they can have good resistance properties. One issue with UV curable inks is that non-polymerized materials may remain in the inks after drying. These may include photoinitiator, photoinitiator fragments, and uncured monomers. It is desirable to inkjet print on materials that include food packaging, pharmaceutical packaging, personal care items, children's toys, etc.; however, there are health and safety concerns associated with migration of the non-polymerized materials.

Electron beam (EB) inks are sometimes preferred over other inks for safety reasons since they cure without photoinitiators and give high conversion of the monomer components. Electron beam curing is being investigated for inkjet printing and some developments by ink suppliers have been reported. The EB inkjet inks that are being developed are related to UV inks in that they contain monomers that polymerize upon curing.

A challenge with both UV and EB inkjet inks is they must be very low in viscosity in order to jet properly in the print heads. Some monomers have a low viscosity which allows jetting; however, low viscosity is often achieved with low molecular weight monomers. These monomers often have associated undesirable odors and do not cure as completely as some higher molecular weight monomers.

Hybrid water-based UV curable inkjet inks are known. These offer the advantage of using water to reduce viscosity to allow jetting so that higher molecular weight UV curable monomer, oligomers, and polymers may be used. The main disadvantage of the water based UV curable materials is that the water must still be removed in order to dry inks. Water based UV curable inks work well on porous substrates that absorb the water before or during the UV curing. It may be possible to use water based UV inks on a non-porous substrate by combining both thermal heating and UV curing. The heat generated by UV lamps or LEDs may also help remove water. A disadvantage of using the heat from a dryer or from the UV source is that it can melt or distort the substrates, especially thin plastic films that may be used in flexible packaging.

In light of this background, there remains a need for improvement in the area of inkjet ink compositions and methods for using the same.

### SUMMARY

In certain aspects, the present disclosure relates to compositions and methods useful for printing on a substrate.

### DETAILED DESCRIPTION OF INVENTION

For the purposes of promoting an understanding of the principles of the invention, reference will now be made to certain embodiments and specific language will be used to describe the same. It will nevertheless be understood that no limitation of the scope of the invention is thereby intended, such alterations and further modifications, and such further applications of the principles of the invention as described herein being contemplated as would normally occur to one skilled in the art to which the invention relates.

We have found surprising and unexpected results in that materials of the present disclosure are effectively dried by EB exposure alone with little or no added heat. These compositions may comprise high molecular weight monomers and polymers which have very low odor and very low migration properties. It has been found that these compositions are very advantageous when used for inkjet printing on many substrates, for example but not limited to, non-porous, heat sensitive substrates including flexible packaging materials.

Water-based electron beam (EB) curable inkjet inks of the present disclosure may comprise a vehicle portion of the ink formulation. Such vehicle portion may comprise water soluble and/or dispersible EB polymerizable and/or crosslinkable monomers, oligomers, and/or polymers. In order for a monomer, oligomer, or polymer to polymerize or crosslink under EB exposure it is beneficial if they have reactive functional groups. Reactive functional groups may include, for example, but are not limited to, acrylates, methacrylates, acrylamides, vinyl ethers, allyl ethers, maleates, itaconates, epoxies, and/or oxatanes. Free radical polymerizable end groups are preferred; but, cationic curing is also possible if, for example, EB activated onium salt catalysts are also included in the formulations. Acrylate groups which are free-radical curable are most preferred due to high reactivity and good commercial availability. Water soluble or dispersible acrylate functional monomers may have acrylate functionality of one up to about 6 equivalents per mole of monomer. Acrylate monomers or oligomers may be ethoxylated (EO) and/or propoxylated (PO) to aid in water solubility and/or dispersion properties. Specific examples include, but are not limited to, the diacrylate ester of 200 to 800 molecular weight polyethylene oxide and 3 to 15 mole ethoxylated trimethylol propane triacrylate. Other functional groups on acrylate monomers or oligomers that may improve water solubility and/or dispersablity may include, but are not limited to, hydroxyl, carboxyl, amino groups and/or their associated salts. Monomers and oligomers with hydroxyl groups may include acrylated epoxy compounds. An example is the diacrylate ester of 1,4-butanediol diglycidyl ether.

Water soluble and/or dispersible acrylate functional polymers may include acrylate functional polyurethane dispersions (PUDs). These include, but are not limited to, the LUX family of products commercially available from Alberdingk Boley. Examples include LUX 220, 250, 255, 260, 701, and 1215. They also include, but are not limited to, the Ucecoat family of products from Allnex. Examples include Ucecoat 7674, 7700, 7717, 7734, and 7788. Other acrylate functional PUD from other suppliers may also be used. Acrylate function polyurethane-acrylic copolymer dispersions may also be used. These include, for example but are not limited to, LUX 286, 399, 430, 441, 481, 484, and 580 from Albedingk Boley. Acrylate functional acrylic dispersions include, but are not limited to, LUX 515 from Alberdingk Boley.

Non-reactive water soluble or dispersible polymers may also be used in certain embodiments. These include, but are not limited to, acrylic and styrene acrylic polymer dispersions available from a wide variety of suppliers. The non-function polymers may be used to together with acrylate functional monomers, oligomers, and/or polymers.

Colorants in the form of pigments and/or dyes may be combined with EB curable vehicles described above to produce inkjet inks. Pigments may be in a dry powder form which can then milled along with a portion of the vehicle or monomers or resins using technology which is well known in the art. The resulting pigment dispersions may have small particle sizes to prevent clogging of the fine orifices in the inkjet heads. Pigments can also be used in a pre-dispersed form. Pigment dispersions are available in particle sizes which may be suitable for use in inkjet printing. Examples of pigment dispersions that are suitable for use in water-based EB curable inks include, but are not limited to, Microlith J products from BASF and/or Hostajet products from Clariant.

In some cases it may be desirable to use dye-based colorants inks rather than pigments. It is desirable to use water based dyes for water based inkjet inks. Suitable dyes include but are not limited to Basacid and Orasol products from BASF and Duasyn products from Clariant.

Colorants may be selected to produce ink colors need for process printing including, but not limited to, four color process printing including, but not limited to cyan, magenta, yellow, and key (“CMYK”) processes and/or for desired spot colors.

The amount of colorants selected may be optimized to give the desired optical density, jetting properties, dot resolution, film properties, and/or other appearance and/or functional properties of the ink.

It may be desirable to include additives in the inkjet ink formulations. Additives for inks may include, but are not limited to, dispersing agents, surfactants, flow modifiers, plasticizers, buffers, lubricants and stabilizers.

The water content of the water based EB curable inks may come from any suitable source, including, but not limited to water which is present in the vehicle components, colorants, or additives. Additional water may also be added as needed. The amount of water may be optimized to give desired viscosity, jetting properties, optical density, drying rate, and/or other appearance and/or functional properties of the inks. The total amount of water may be less than about 100 percent, less than about 90 percent, less than about 80 percent, less than about 70 percent, and/or less than about 60 percent. The total amount of water is preferably about 20 percent to about 90 percent by weight of the total print-ready ink formulation. The amount of water is more preferably in the range of about 30 percent to about 80 percent. The percent water defined by the weight of water compared to the weight of the total formula to be inkjet printed.

The water-based EB curable inkjet inks described above may be deposited in any suitable manner. In certain preferred embodiments, one or more inks are jetted onto the desired substrate. The desired substrate may include three-dimensional parts as well as flat sheets or webs that are supplied in roll form. Water based EB curable inkjet inks may be printed on both porous and non-porous substrates. One advantage of using these inks on porous substrates is that EB energy is capable of penetrating into the substrate to cure the inks after the ink has partially penetrated into the substrate. This is a limitation of curing with UV where curing is limited to materials where the UV energy can penetrate. Examples of porous substrates include, but are not limited to, paper, wood, membranes, and fabrics (including, for example, but not limited to, woven and non-woven).

Water-based EB curable inkjet inks may be printed on non-porous substrates. One advantage of using these inks on non-porous substrates is that EB curing in addition to polymerizing and crosslinking the ink vehicle components, it also helps to remove water. Conventional water based inkjet inks work well on porous substrates where the water is absorbed into the substrates. Conventional water based inks may be a challenge to dry on non-porous substrates and may require extended thermal dryers. For many types of plastic film substrates it is advantageous to use water-based EB curable inkjet inks as the EB curing process may generate little heat it prevents melting or distortion of the film that can occur in a thermal drying process.

Non-porous substrates may include, but are not limited to, various plastics, glass, metals, and/or coated papers. These may include, but are not limited to, molded plastic parts as well a flat sheets or rolls of plastic films. Common types of plastic films include, but are not limited to, films used in packaging applications. Examples of films used in packaging applications include, but are not limited to, polyester (PET), polypropylene (PP), polyethylene (PE), polylactic acid (PLA), and/or polystyrene (PS). PE based films may be mono-layer films or multi-layer films up to about nine layers including barrier polymer layers. Films may have coatings or skin layers to provide various functional and appearance properties. These include, but are not limited to, metalization, barrier coatings, heat sealing layers, and/or print receptive primers. Films may also contain pigments, fillers, and/or air voids to add color and/or opacity. Films may include heat shrink films used to produce shrink labels including sleeve labels. Metal substrates include, but are not limited to, aluminum foil. Multi-layer laminated substrates may also be used. Examples of multi-layer laminated substrates may include, but are not limited to, PET/PE, PET/Al foil/PE, PE/paper, and/or paper/PE/Al foil/PE.

Many of the substrates described above may be used in the production of printed packaging. The different types of packaging include flexible packaging, labels, folding cartons, rigid plastic containers, glass containers, and/or metal cans. Rigid plastic containers include bottles, jars, tubs, and tubes. The printed packaged containers may contain food products, non-food products, pharmaceutical, and/or personal care items. In some cases printing may be performed direct on personal care items. Water-based EB curable inkjet inks are well suited for packaging for food, pharmaceutical, and personal care items since water is the primary diluent for the ink to provide low viscosity to allow jetting. The monomers, oligomers, are higher molecular weight and are not likely to cause odor or migration issues. The EB also provides consistent energy deposition in the inks which results in high conversion of the acrylate functional groups to a give a crosslinked polymer network.

Migration testing is often used to determine the potential for ink components to enter the package and adulterate the packaged product. Migration testing methods often involve the use food simulants to mimic migration into food products. Water based EB curable inkjet inks may give low migration upon curing. In certain embodiments, migration levels of ink components may be below about 100 ppb, below about 90 ppb, below about 80 ppb, below about 70 ppb, below about 50 ppb, and/or below about 10 ppb. Migration levels of ink components into the food simulants are preferably below about 50 ppb and more preferably may be less than about 10 ppb which may allow compliance with food and pharmaceutical packaging regulations in many regions of the world including FDA regulations in the US.

The inkjet inks of the present disclosure may be cured with low energy electron beam systems. Electrons are generated by an electrically operated filament and accelerated by a controlled voltage potential. Low energy EB systems operate at an accelerating potential of less than about 300 kV. Electrons emerge from a vacuum chamber through a metal foil and reach the printed substrate at atmospheric pressure. The most useful systems for this invention are self-shielded, meaning the shielding needed to prevent harmful X-ray emission is self-contained as part of the system. These types systems are commercially available from PCT Engineered Systems and include BroadBeam CE, LE and EP series systems. Commercial systems are also available from Energy Sciences and include EZCure and ElectroCure systems. Many electron beam systems use pumps to maintain a vacuum in the cathode chamber. Sealed EB emitters that maintain a vacuum without active pumping are also available from the ebeam division of Comet AG.

In certain embodiments, it is preferred to use EB systems where the width of the emitted beam is at least as wide as the printed substrate. In certain embodiments, it is possible to use an EB system where the desired width is achieved by scanning a narrow beam using a controlled magnetic field. In additional embodiments, it is possible to use compact sealed tube EB emitters which move in a motion which corresponds to the application of ink from the inkjet heads.

As stated above the inkjet printed substrate may be of any suitable material which, in certain embodiments can be wound onto rolls. The EB curable systems disclosed herein may include rollers which transport the web in and out of the system and the associated shielding. The web may unsupported as it is exposed to EB and/or it may be supported by chill roll. A chill roll configuration is preferred for heat sensitive film substrates.

The substrates suitable for use in embodiments of the present disclosure may be a flat sheet or a three-dimension object. EB systems may incorporate designs which transport these substrates in and/or out of the beam while maintaining X-ray shielding.

Electron beam irradiation is characterized by the voltage used to accelerate the electrons and/or the dose delivered to the substrate. Accelerating potentials for curing water-based EB curable inkjet inks are preferably below about 300 kV and more preferably in the range of about 70 kV to 200 kV. Preferred dose levels to cure acrylate functional water-based EB curable inks are preferably in the range of about 5 kGy to about 100 kGy and more preferably in the range of about 10 kGy to about 60 kGy.

An inert gas may be used during EB curing to displace oxygen (“inerting”) which inhibits free-radical polymerization. In certain embodiments, less than about 200 ppm oxygen is present in the reaction chamber during curing. Any suitable inert gas may be used in processes of the present disclosure, including, but not limited to nitrogen gas. Inerting can be used during the EB curing of water-based EB curable inkjet inks. The amount of inerting needed for curing may be reduced due to the simultaneous emission of water vapor from the ink layer which helps to displace oxygen. Increased viscosity which occurs during the drying can also reduce the need for inerting due to decreased diffusion of oxygen into the ink layer.

As shown in the Examples included herein which form a part of the specification, conversion of the water-based EB curable layer to a dry tack-free state may occur with EB exposure alone without additional thermal drying. In some embodiments, it may be beneficial to combine thermal drying with EB curing. Thermal drying can help the removal of water while the EB serves to polymerize and crosslink the monomer, oligomer, and/or polymer portions of the ink. Thermal energy may be delivered by infrared lamps and/or heated air. Thermal drying may occur before, during, and/or after EB exposure. In certain embodiments, it is preferable to have thermal drying performed before EB exposure. Due to action of EB curing the amount of thermal drying needed may be reduced. The reduced need for thermal drying can be compared to a conventional water-based inkjet ink with similar water content and applied weight. The reduced need for thermal drying may be realized by some combination of higher line speeds, shorter dryers, lower dryer temperatures, and/or reduced energy usage.

Water-based EB curable inkjet inks may be effectively dried by EB or some combination of EB and/or thermal energy. Effective drying of the inks can be defined by the end-use application. In some embodiments, an ink only needs to be dry and tack-free to the touch. In other embodiments, the ink must have some level of scuff and abrasion resistance to function in the end-use application. In certain embodiments, printed inks may have resistance to water in order to maintain a clear image in a moist environment. Resistance to food products, health and beauty aids, household cleaners, and/or automotive products is often needed for packaging applications. The effective drying of water-based EB curable inkjet inks may be controlled by the ink formulation, modifications of the polymer structure, and also the curing conditions.

Most inkjet printing involves the application of multiple ink colors from separate print heads. Computer controlled action of print heads in relation to the motion of the substrate can produce the desired image. In some cases multiple colors of water-based inkjet inks may be applied and cured with a single electron beam or a combination of thermal and electron beam drying. In other embodiments it may be advantageous to at least partially dry one color before application of the next color (“interstation drying”). Such interstation drying may be achieved by thermal drying which removes at least a portion of water in the ink. It may also be achieved using multiple electron beam systems.

In certain preferred embodiments, interstation drying is achieved by partially curing or “pining” the inks with UV or visible light exposure. After UV or visible light pinning, the inks may still be tacky and/or exist in a gel-like state. In certain embodiments, the inks need only to be dry enough of an extent to prevent mixing of the different color jetted ink dots. When UV or visible light pinning is utilized, inks may preferably contain less than about 5% of free-radical photoinitiator. UV or visible light energy for pinning may be provided by any suitable method, including, but not limited to arrays of LEDs or by conventional lamps such as medium press mercury vapor lamps.

### EXAMPLES

In order to promote a further understanding of the present invention and its various embodiments, the following specific examples are provided. It will be understood that these examples are illustrative and not limiting of the invention.

### Example 1

An EB curable composition was prepared by mixing 70% by weight of an acrylate functional polyurethane dispersion in water (Alberdingk Boley Lux 350) and 30% by weight of 9-mole ethoxylated trimethylol propane triacrylate. The mixture has a calculated water content of 42%.

### Example 2

The mixture from example 1 was applied at a weight of 4.0 g/m2 on to web of 12 micron thick polyethylene film moving at 50 ft/min. Immediately after coating the web with wet coating was passed into the reaction chamber of a BroadBeam EP series EB processor operating at a dose setting of 40 kGy at 150 kV. The reaction chamber of the EB processor used a chill roll to support the film as it passed under the beam. The chill roll limits the temperature change of the substrate to less than 5 degrees C. The coating was completely dry and track-fee immediately upon exiting the reaction chamber. The dry coating weight determined by weighing a section of coated film was 2.3 g/m2. The difference between the wet and dry coating weight corresponds to the water content of the mixture given in example 1 and indicates the water was effective removed by EB curing without any supplemental thermal drying.

### Example 3

The test from Example 2 was repeated with EB dose settings of 30, 20, 10, and 5 kGy dose settings. The coating was dry and tack free immediately upon exiting the EB at all dose levels. It was surprising and unexpected that curing occurred at dose levels as low as 5 kGy. When the beam was shut off (0 kGy dose) the coating was wet to touch upon exiting the EB system.

### Example 4

The test from Example 2 was repeated applying coating with #10, 12, 16, 22, and 28 Meyer rods. The highest rod number applies wet coating weights greater than 25 g/m2. The coating was completely dry and tack-free immediately upon exiting the reaction chamber. It was surprising and unexpected that these heavy coating weights provide drying by EB curing alone.

### Example 5

The test from Example 2 was repeated applying coating with a #10 Meyer rod and running line speeds of 100, 150, 250, and 300 ft/min. The coating was completely dry and tack-free immediately upon exiting the reaction chamber. It was surprising and unexpected that drying occurs at these line speeds by EB curing alone.

### Example 6

Water was added to the formulation from Example 1 at levels of 10, 20, 30, and 40% percent by weight. This produced formulations with calculated water content of 47.8, 53.6, 59.4, and 65.2% respectively. These formulations were cured using the procedure of Example 2. The coatings were dry and tack-free immediately after curing with up to 30% added water. At 40% added water the coating was dry but could be easily marred indicating incomplete removal of water.

### Example 7

Colorants in the form of dispersed pigments and dyes including Microlith, Basacid, or Orasol products from BASF and Hostajet or Duasyn products from Clariant are combined with the formulation from Example 1. Additives including dispersants may be included to produce water-based EB curable inks.

### Example 8

The inks from Example 7 after filtration as needed are fed into inkjet printing heads and jetted on to a non-porous substrate. EB curing at a dose of 5 to 40 kGy give a dry tack-free ink layer.

### Example 9

The inks from Example 7 after filtration as needed are fed into inkjet printing heads and jetted onto porous substrates. The porous substrates include paper and fabrics. The fabrics are non-woven, woven, or knit and include fabrics made from natural fibers as well as synthetic polymers. EB curing at doses from 5 to 40 kGy dry inks even if some portion or the ink has penetrated into the porous material.

The uses of the terms “a” and “an” and “the” and similar references in the context of describing the invention (especially in the context of the following claims) are to be construed to cover both the singular and the plural unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While the invention has been illustrated and described in detail in the drawings and the foregoing description, the same is to be considered as illustrative and not restrictive in character, it being understood that only the preferred embodiment has been shown and described and that all changes and modifications that come within the spirit of the invention are desired to be protected. In addition, all references cited herein are indicative of the level of skill in the art and are hereby incorporated by reference in their entirety.

1. An ebeam curable ink that is free of a photoinitiator, comprising:
a. an acrylate functional polyurethane dispersion in water,
b. a 3 to 15 mole ethoxylated trimethylol propane triacrylate, and
c. one or more colorants,
d. with the water comprising from 30 to 80% of the ink and being free of a photoinitiator.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. An ebeam-cured process for inkjet printing on a substrate comprising the acts of:
a. Providing a substrate;
b. Providing an ebeam curable ink that is free of a photoinitiator, and comprising an acrylate functional polyurethane dispersion in water, a 3 to 15 mole ethoxylated trimethylol propane triacrylate, and one or more colorants, with water comprising from 30 to 80% of the ink;
c. Providing an inkjet printing head;
d. Applying the ebeam curable ink to the moving substrate through one or more inkjet printing heads;
e. Moving the substrate through an ebeam reaction chamber, wherein the ebeam reaction chamber comprises one or more chill rolls;
f. Contacting the substrate with the one or more chill rolls while the substrate is moving through an ebeam reaction chamber; and
g. Curing the ebeam curable ink in the ebeam reaction chamber while the moving substrate is contacted with the one or more chill rolls.

20. The ink drying process of claim 19, wherein the water based ink is effectively dried using the electron system alone without a thermal dryer.

21. The ink drying process of claim 19, wherein the ink is effectively dried by the electron beam system along with supplemental thermal drying where the duration of the non-porous substrate in the thermal drier and/or temperature of the thermal dryer is reduced compared to a water based inkjet ink that has a similar level of water content but does not contain any water soluble or dispersible acrylate functional monomer, oligomer, or polymer.

22. (canceled)

23. (canceled)

24. (canceled)

25. (canceled)

26. (canceled)

27. (canceled)

28. The ink drying process of claim 21, wherein the substrate is part of package used to contain a food, pharmaceutical, or personal care product.

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)
